(19) United States
(12) Patent Application Publication
(10) Pub. No.: US 2010/0270513 A1
(43) Pub. Date: Oct. 28, 2010

(54) CONDUCTIVE SOLID FILM MATERIAL

(76) Inventors: Luke Haylock, Culver City, CA (US); Liang Zeng, Irvine, CA (US)

Correspondence Address: INTELLECTUAL PROPERTY, ALCOA TECHNICAL CENTER, BUILDING C, 100 TECHNICAL DRIVE, ALCOA CENTER, PA, 15069-0001, US

(21) Appl. No.: 12/753,347

(22) Filed: Apr. 2, 2010

Related U.S. Application Data
(60) Provisional application No. 61/166,618, filed on Apr. 3, 2009.

(51) Int. Cl. H01B 1/24

(52) U.S. Cl. 252/511; 252/510; 977/742

(57) ABSTRACT

A coating composition including a base composition, comprising at least one organic material and a plurality of carbon nano-tubes, wherein a concentration of the carbon nano-tubes is between 0.05 to 30 percent of a total weight of the coating composition, wherein the base composition comprises: i) methyl ethyl keton, ii) phenolic resin, and iii) ethyl alcohol, wherein each of the plurality of carbon nano-tubes has a length up to about 1.0 mm, wherein a diameter of each of the plurality of carbon nano-tubes is in a range from about 3 nm to about 200 nm, wherein the coating composition has a volume resistivity in a range from about 1×10⁻⁸ to about 10³ ohm-m, and wherein the coating composition has a friction coefficient that is lower than about 0.2μ.

### RELATED APPLICATIONS

This application claims the benefit of U.S. provisional application Ser. No. 61/166,618 filed Apr. 3, 2009, and entitled “CONDUCTIVE SOLID FILM MATERIAL,” which is hereby incorporated by reference herein in the entirety for all purposes.

### TECHNICAL FIELD

The present invention relates to electrically conductive coating and their uses.

### BACKGROUND

Electrically conductive coatings are used for a variety of applications, such as charge dissipation and radio frequency interference (EMI/RFI) shielding. The amount of direct current conductivity required is dependent upon the specific application. Electric charge buildup by dielectric substrates, such as fiberglass structures in frictional contact with other materials, can result in very large static voltages that may result in dangerous discharge sparks. The amount of surface resistivity required to effectively bleed off this charge and prevent sparking is usually rather low, 10⁶ to 10⁹ Ω/cm².

### SUMMARY OF INVENTION

In some embodiments, a coating composition of the present invention comprises a base composition, comprising at least one organic material and a plurality of carbon nano-tubes, wherein a concentration of the carbon nano-tubes is between 0.05 to 30 percent of a total weight of the coating composition.

In some embodiments, the coating composition of the present invention comprises a base composition that is similar in physical and/or chemical characteristics to a composition that comprises i) methyl ethyl keton, ii) phenolic resin, and iii) ethyl alcohol.

In some embodiments, the coating composition of the present invention comprises carbon nano-tubes that have a length up to about 1.0 mm.

In some embodiments, the coating composition of the present invention comprises carbon nano-tubes that have a diameter which varies from about 3 nm to about 200 nm.

In some embodiments, the coating composition of the present invention is sufficiently designed to have electric conductivity comparable to metallic or semi-conductive material.

In some embodiments, the coating composition of the present invention is applied to a fastener.

In some embodiments, the coating composition of the present invention has a volume resistivity in a range from about 1×10⁻⁸ to about 10³ ohm-m.

In some embodiments, the coating composition of the present invention has a friction coefficient that is lower than about 0.2μ.

### BRIEF DESCRIPTION OF THE DRAWINGS

FIG. 1 shows a magnified view of a sleeve of a conventional fastener after a lightning strike test, without using the invention.

FIG. 2 shows a magnified view of a portion of an installed conventional fastener.

FIGS. 3-6 show graphs concerning some embodiments of the invention.

FIG. 7 shows magnified views of some embodiments of the invention.

FIG. 8 shows magnified views of some other embodiments of the invention.

FIG. 9 shows a graph concerning some embodiments of the invention.

Among those benefits and improvements that have been disclosed, other objects and advantages of this invention will become apparent from the following description taken in conjunction with the accompanying figures. The figures constitute a part of this specification and include illustrative embodiments of the present invention and illustrate various objects and features thereof.

### DETAILED DESCRIPTION

Detailed embodiments of the present invention are disclosed herein; however, it is to be understood that the disclosed embodiments are merely illustrative of the invention that may be embodied in various forms. In addition, each of the examples given in connection with the various embodiments of the invention are intended to be illustrative, and not restrictive. Further, the figures are not necessarily to scale, some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

The present invention provides for a conductive solid film material (“CSF”) incorporating carbon nano-tubes (“CNTs”) (“the CSF-CNTs material”).

One use of an embodiment of the present invention is to coat a core pin, and/or an inside surface, and/or outside surface of a conforming sleeve.

In some embodiments, the conductive solid film material decreases or eliminates the internal arcing between the pin and the sleeve.

Embodiments of the CSF materials typically have the following main ingredients: methyl ethyl ketone at a concentration of <30-40%, phenolic resin at a concentration of <5-10%, and ethyl alcohol at a concentration of <30-40%, or other similar suitable compositions.

In an embodiment, the CSF material may exhibit fluid-like behavior. In an embodiment, the CSF may have low viscosity. In some embodiments, the CSF material may be used as a lubricant—a substance (often a liquid) introduced between two moving surfaces to reduce the friction between them, improving efficiency and reducing wear; a lubricant may also have the function of dissolving or transporting foreign particles and for distributing heat.

In some other embodiments, the CSF material may be used as a coating—a covering that is applied to an object, usually with the aim of improving surface properties of a base material, usually referred to as a substrate. Such surface properties may include, amongst others, appearance, adhesion, wettability, corrosion resistance, wear resistance, and scratch. The coatings may be applied as liquids, gases or solids.

In some embodiments, the preferred CSF material would possess a low friction coefficient which would be substantially less than a friction coefficient of 1. In some embodiments, commercially available fastener coatings, such as Incotec Corp.'s 8G Aluminum coating, Teclube coating, or any aluminum pigment coating, may be used as the CSF material.

The CNTs are carbon compounds with a nano diameter of about between 3 and 200 nm and may have a length-to-diameter ratio as large as 28,000,000:1. The CNTs' length may be up to about 1.0 mm. The CNTs may exhibit very good thermal conductivity along the tube, but good insulation laterally to the tube axis. The CNTs may exhibit tensile strength which is around fifty (50) times higher than steel. Certain CNTs may possess electric conductivity comparable to metallic or semi-conductive material, depending on the CNTs structure. Typically, the CNTs may have density of 1.3 to 2 g/cm³. The CNTs may be single-walled or multi-walled structures. The CNTs may possess small quantity of impurities, such as metal and or amorphous carbon. The CNTs are typically very resistant to oxidation and can even hold up against lengthy immersions in strong acids. In addition, the CNTs are typically not considered acutely toxic, harmful to environment, or made from precious or limited supply precursors.

In some embodiments, the CSF-CNTs materials are made using commercially available CNTs—IGMWNTs 90 wt % and IGMWNTs 90 wt % COOH—from Cheap Tubes, Inc. CNTs from other suppliers, for example Nanocyl, may be used.

In embodiments of the CSF-CNTs material, the CNTs may be dispersed into a solvent with the addition of a small amount of surfactant-wetting agent that lowers the surface tension of a liquid, allowing easier spreading, and lowers the interfacial tension between two liquids.

In an embodiment, the CSF-CNTs material contains CNTs with a diameter between about 3-30 nm.

In an embodiment, a sufficient amount of CNTs in the CSF-CNTs material may induce high conductivity of the CSF-CNTs material without substantial increase in stiffness of the CSF-CNTs material.

In embodiments, addition of CNTs significantly reduced or eliminated the need to use metal with high conductivity to achieve the same properties of the CSF-CNTs material without a substantial increase in stiffness in contrast to the stiffness property of the base CSF material.

Embodiments of the CSF-CNTs material with CNTs at a concentration of around 1% experience a reduction in resistivity from >10¹² Ω/square to ˜10⁵ Ω/square. Embodiments of the CSF-CNTs material with some CNTs at a concentration of over 1% experience further reductions in resistivity to around 500 Ω/square. Using embodiments of the CSF-CNTs material as an aerospace fastener coating provides, for example, fasteners with the desirable property of high conductivity with minimum or no metal particles. Further, in some CSF-CNTs embodiments, the CNTs' size and low loading benefit the surface quality of the coating done with the CSF-CNTs material.

In some embodiments, the CSF-CNTs material may typically contain CNTs at concentrations between 0.05% and 30% of a total weight of the CSF-CNTs material. In some embodiments, the CSF-CNTs material may typically contain CNTs at concentrations between 0.1% and 10% of a total weight of the CSF-CNTs material. In some embodiments, the CSF-CNTs material may typically contain CNTs at concentrations between 1% and 10% of a total weight of the CSF-CNTs material. In some embodiments, the CSF-CNTs material may typically contain CNTs at concentrations between 3% and 15% of a total weight of the CSF-CNTs material.

In some embodiments, compositions of the CSF-CNTs material may have a volume resistivity that is approximately less than 10³ ohm-m (measured, for example, in accordance with ASTM D257). In some embodiments, compositions of the CSF-CNTs material may have a volume resistivity that is approximately less than 10² ohm-m. In some embodiments, compositions of the CSF-CNTs material may have a volume resistivity that is approximately less than 10 ohm-m. In some embodiments, compositions of the CSF-CNTs material may have a volume resistivity that is approximately less than 10⁻³ ohm-m. In some embodiments, compositions of the CSF-CNTs material may have a volume resistivity that is between 1×10⁻⁸ ohm-m and 4×10⁻⁵ ohm-m.

In some embodiments, compositions of the CSF-CNTs material may have a friction coefficient that is approximately less than 0.12μ (measured, for example, on a Falex test machine). In some embodiments, compositions of the CSF-CNTs material may have a friction coefficient that is approximately less than 0.10μ (measured, for example, on a Falex test machine). In some embodiments, compositions of the CSF-CNTs material may have a friction coefficient that is approximately less than 0.2μ (measured, for example, on a Falex test machine). In some embodiments, compositions of the CSF-CNTs material may have a friction coefficient that is approximately less than 0.3μ (measured, for example, on a Falex test machine). In some embodiments, compositions of the CSF-CNTs material may have a friction coefficient that is approximately less than 0.5μ (measured, for example, on a Falex test machine). In some embodiments, compositions of the CSF-CNTs material may have a friction coefficient that is approximately less than 0.8μ (measured, for example, on a Falex test machine). In some embodiments, compositions of the CSF-CNTs material may have a friction coefficient that is approximately between 0.04μ and 0.5μ (measured, for example, on Falex test machine). In some embodiments, compositions of the CSF-CNTs material may have a friction coefficient that is approximately between 0.04μ and 1μ (measured, for example, on Falex test machine).

In embodiments, the CSF-CNTs material's desirable properties may also include a simplicity—a small number of ingredients and lack of special handling procedures.

Table 1 below compares some properties of an embodiment of the CSF-CNTs material based on the commercially available Teclube coating to the properties of Teclube coating itself. Table 1 shows that an embodiment of the CSF-CNTs material, which contains 0.02% of CNTs, demonstrates substantially lower volume resistivity in contrast to the base Teclube coating. Table 1 shows that adding CNTs did not substantially effect the fluidity, i.e., thickness, of Teclube coating with CNTs in contrast to Teclube coating without CNTs.

TABLE 1

| | | | Volume Resistivity @ 10 V |
|---|---|---|---|
| Coating | Thickness | Type of spray | (ohm-m) |
| Teclube | 0.0006 inch | Normal | 2.02 × 10 E12 |
| Teclube with | 0.0005 inch | Normal | <10 E3 (below equipment |
| 0.02% CNT | | | limitations) |

This CSF-CNTs material may be used in variety of applications. In one embodiment, the CSF-CNTs material is used to coat aerospace fasteners. An embodiment of the CSF-CNTs material possesses sufficiently high conductivity enough to provide at least partial protection from lightning strikes. High conductivity, especially near metallic fasteners, is typically necessary for directing large currents, such as those experienced in lightning strikes on airplane composite structures. An embodiment of the CSF-CNTs material provides fasteners with qualities of high thermal conductivity, less weight, and strong resistance to oxidation. In embodiments, since CNTs typically have density around 2.0 g/cm³—which is approximately one quarter of the density of typical metal particles or flakes that is generally more than 8 g/cm³, —using the CSF-CNTs material helps to reduce aerospace fastener coating weight and overall airplane weight. Further, using embodiments of the CSF-CNTs material as aerospace fastener coating substantially enhances physical properties, including electric and thermal conductivity, reduce mass, toughness and durability at low concentrations of CNTs over concentrations of metals in conventional metal based conductive coatings.

In some embodiments, the CSF-CNTs material is applied to the outside surface of the sleeve, which is exposed to the walls of a slot which receives the fastener. In some embodiments, the CSF-CNTs material is applied to both inside and outside surfaces of the sleeve. In some embodiments, the CSF-CNTs material is applied to both the surface of the pin and the interior surface of the sleeve. In some embodiments, the CSF-CNTs material is applied to the surface of the pin. In some embodiments, the CSF-CNTs material is applied to all surfaces of the sleeve and the pin. Applying the CSF-CNTs material to either the inside walls of the sleeve or to the exterior surface of the pin, or to both of these surfaces, reduces resistance which the pin experiences during its introduction into the sleeve. In some embodiments, having the CSF-CNTs coating between the surface of the pin and the interior surface of the sleeve provides at least partial protection from lightning strikes.

In some embodiments, the CSF-CNTs material is applied to a surface of an article by way of spraying or using any other comparable technique. In some embodiments, the CSF-CNTs material is deposited onto a surface of an article, when the article is maintained in an environment (e.g. CNTs' reach solution) that facilities the growth, and/or attachment, and/or deposition of CNTs (and other ingredients of a particular composition of the CSF-CNTs material) onto the surface.

In some embodiments, benefits provided by having a layer of the CSF-CNTs material are obtained when the CSF-CNTs layer has a thickness between approximately 3 microns (μm) and 25 microns (μm). In some embodiments, benefits provided by having a layer of the CSF-CNTs material are obtained when the CSF-CNTs layer has a thickness between approximately 5 microns (μm) and 20 microns (μm). In some embodiments, benefits provided by having a layer of the CSF-CNTs material are obtained when the CSF-CNTs layer has a thickness between approximately 3 microns (μm) and 15 microns (μm). In some embodiments, benefits provided by having a layer of the CSF-CNTs material are obtained when the CSF-CNTs layer has a thickness between approximately 10 microns (μm) and 25 microns (μm). In some embodiments, benefits provided by having a layer of the CSF-CNTs material are obtained when the CSF-CNTs layer has a thickness between approximately 10 microns (μm) and 20 microns (μm). In some embodiments, benefits provided by having a layer of the CSF-CNTs material are obtained when the CSF-CNTs layer has a thickness between approximately 3 microns (μm) and 10 microns (μm).

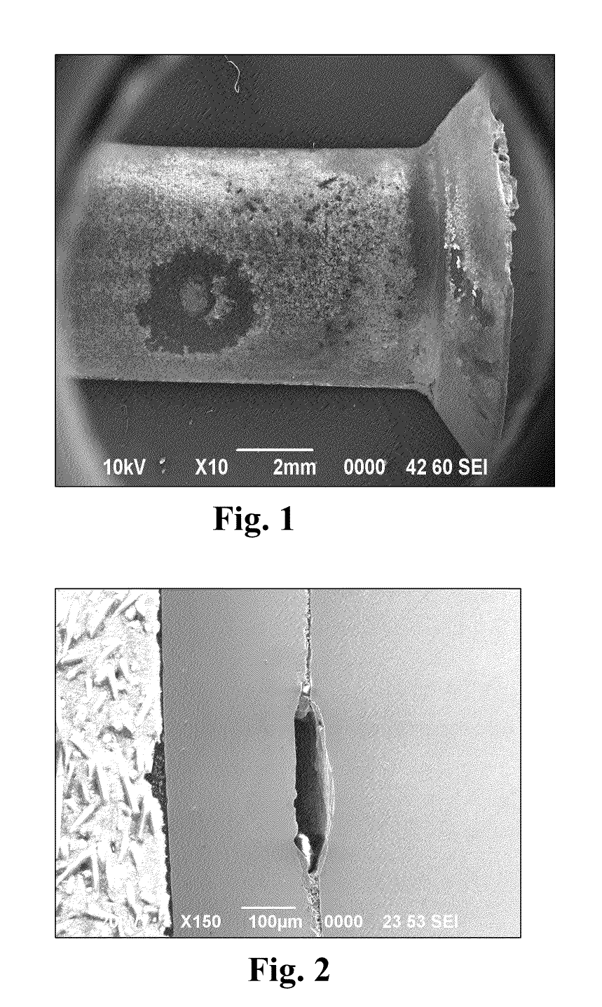

FIG. 1 is a macro level photo of a conventional fastener sleeve without the CSF-CNTs coating after a lightning strike test, showing a severely damaged surface of the sleeve.

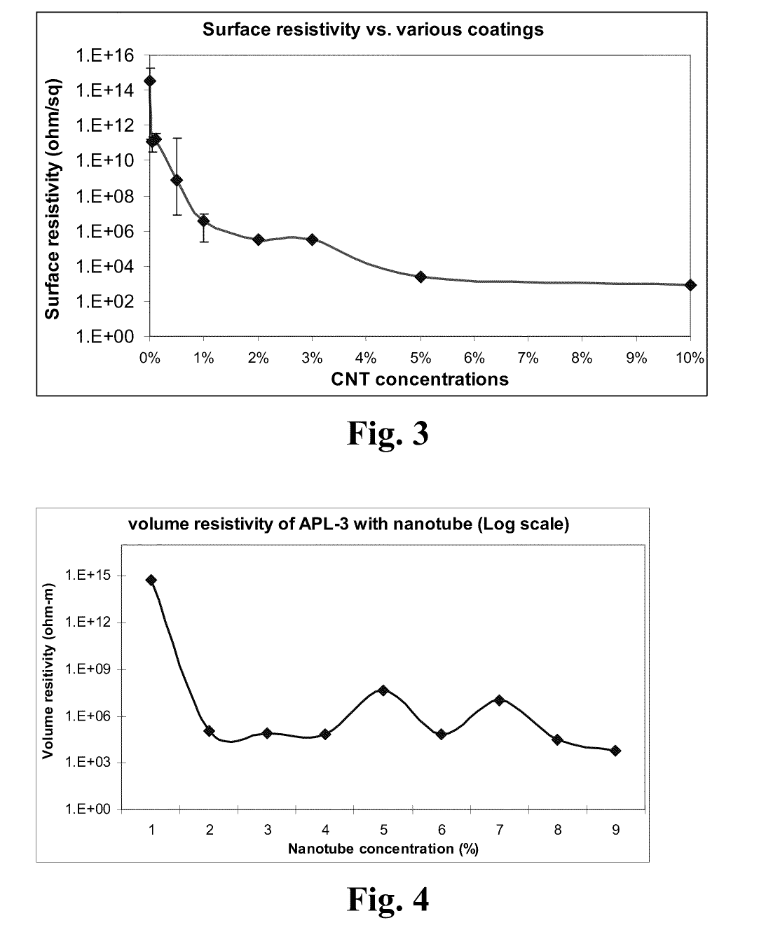

FIG. 2 is a macro level photo showing a hole in a gap between a sleeve of a conventional fastener and a wall of a slot which receives the fastener. In embodiments, the CSF-CNTs coating may substantially fill this hole, preventing or decreasing chances of the lightning-induced sparking.

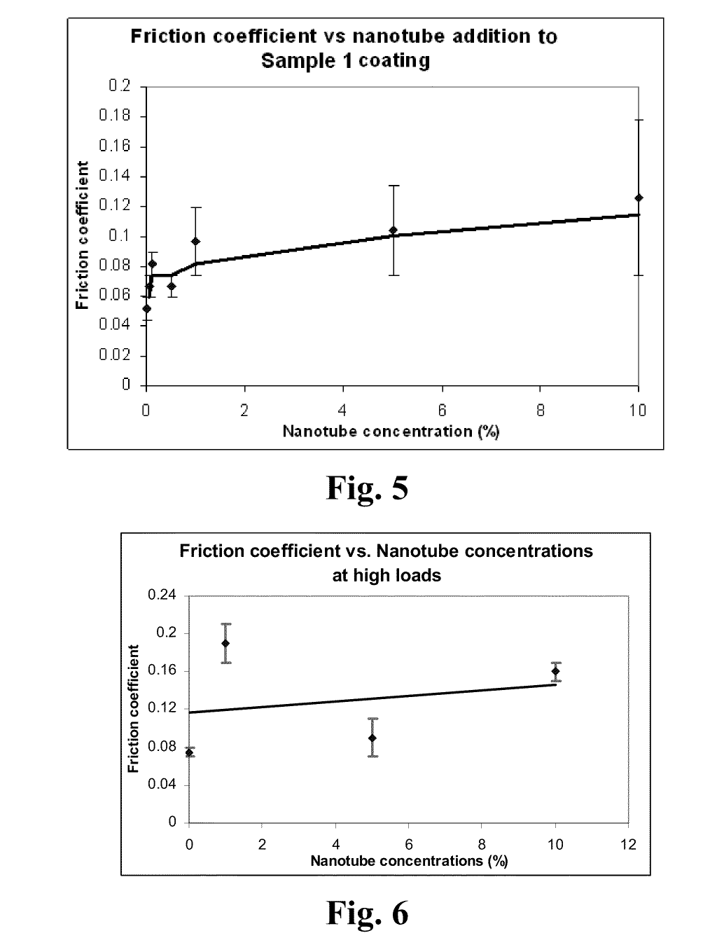

FIG. 3 is a graph showing how increasing the concentration (total weight %) of CNTs in some embodiments of the CSF-CNTs materially effects surface resistivity of those embodiments as coatings. The coating was applied onto a fiberglass substrate.

FIG. 4 is a graph showing how increasing the concentration (total weight %) of CNTs in an embodiment of the CSF-CNTs material effects volume resistivity of the embodiment. The graph shows that for this particular embodiment, adding 0.050% of CNTs produces the desirable drop in the volume resistivity. The coating was applied onto a metal substrate.

FIG. 5 is a graph showing how increasing the concentration of CNTs in an embodiment of the CSF-CNTs material (Sample 1) effects the friction coefficient of the embodiment. The graph shows that increasing the concentration of CNTs in this particular CSF-CNTs coating leads to a slow and gradual increase in friction coefficient. Measurement of the friction coefficient was conducted using a Falex testing machine at a load of 200 pounds.

FIG. 6 is a graph showing how high concentrations (total weight %) of CNTs in another embodiment of the CSF-CNTs material affect the friction coefficient of the embodiment. The graph shows that increasing the concentration of CNTs in this particular CSF-CNTs coating leads to a consistent increase in friction coefficient. Measurement of the friction coefficient was conducted using a Falex testing machine at a load of 500 pounds.

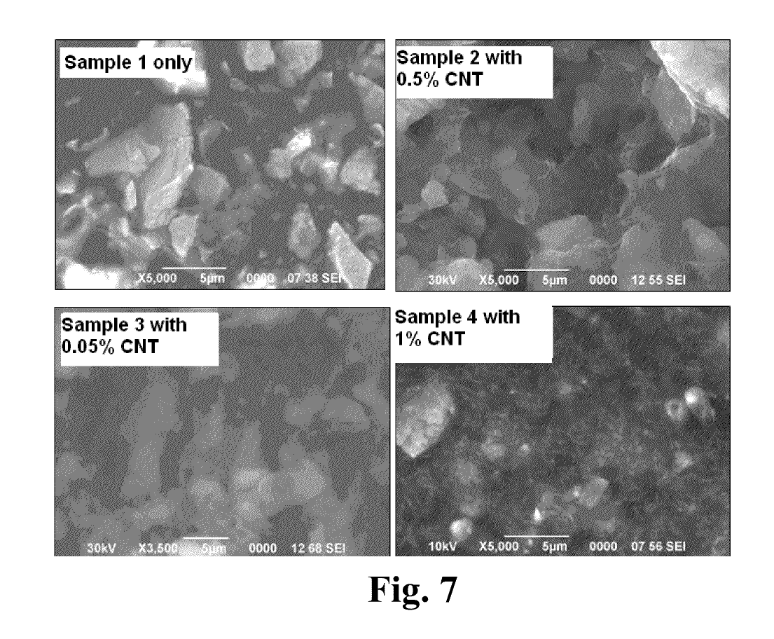

FIG. 7 are macro level photos of the physical consistency of embodiments of the CSF-CNTs coatings having various concentrations (total weight %) of CNTs in them. The top left photo shows the physical consistency of a CSF coating with no CNTs. The bottom left photo shows the physical consistency of a CSF-CNTs coating containing 0.05% of CNTs in its body. The top right photo shows the physical consistency of a CSF-CNTs coating containing 0.5% of CNTs in its body. The bottom right photo shows the physical consistency of a CSF-CNTs coating containing 1% of CNTs in its body.

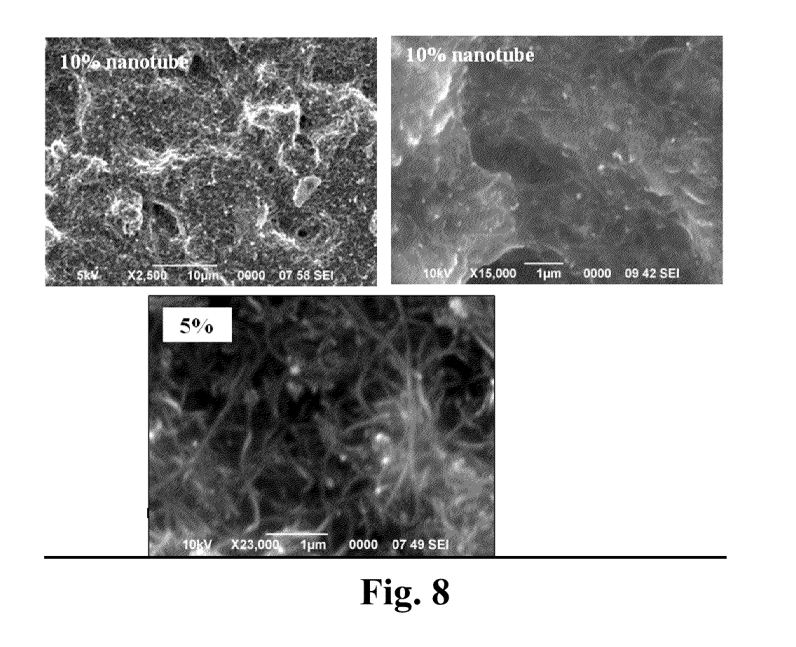

FIG. 8 are macro level photos of physical consistency of embodiments of the CSF-CNTs coatings having various concentrations (total weight %) of CNTs in them. The top left photo, taken at a lower magnification, shows the physical consistency of a CSF-CNTs coating containing 10% of CNTs in its body. The top right photo, taken at a higher resolution, shows the physical consistency of a CSF-CNTs coating containing 10% of CNTs in its body. The bottom photo shows the physical consistency of a CSF-CNTs coating containing 5% of CNTs in its body.

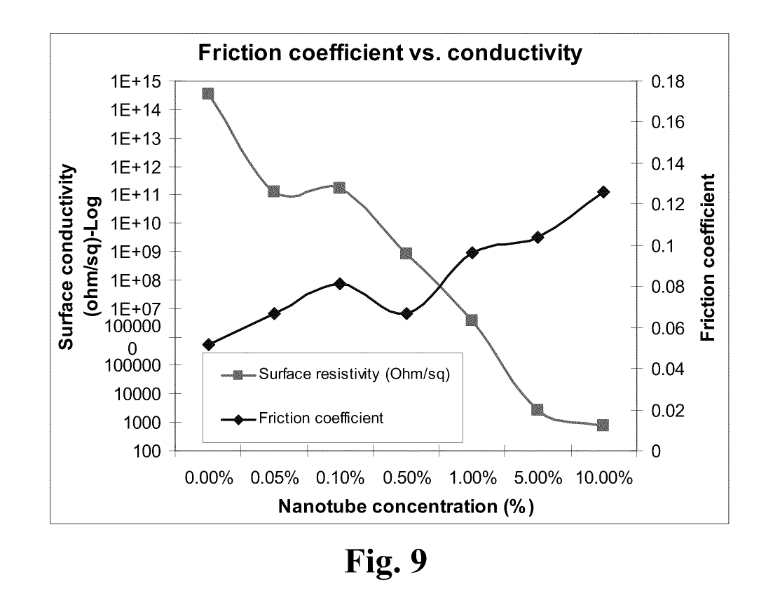

FIG. 9 is a graph showing effects on surface conductivity (top-to-bottom, pink line) and friction coefficient (bottom-to-top, blue line) of embodiments of the CSF-CNTs material having various concentrations (total weight %) of CNTs. In some embodiments, the concentrations of CNTs between about 0.05% to about 3.0% provides a desired increase in surface conductivity without substantial increase in the friction coefficient of the embodiments.

We claim:

1. A coating composition, comprising:
a base composition, comprising at least one organic material;
a plurality of carbon nano-tubes; and
wherein a concentration of the carbon nano-tubes is between 0.05 to 30 percent of a total weight of the coating composition.

2. The coating composition of the claim 1, wherein the base composition comprises:
i) methyl ethyl keton,
ii) phenolic resin, and
iii) ethyl alcohol.

3. The coating composition of the claim 1, wherein each of the plurality of carbon nano-tubes has a length up to about 1.0 mm.

4. The coating composition of the claim 1, wherein a diameter of each of the plurality of carbon nano-tubes is in a range from about 3 nm to about 200 nm.

5. The coating composition of the claim 1, wherein the coating composition has a volume resistivity in a range from about 1×10⁻⁸ to about 10³ ohm-m.

6. The coating composition of the claim 1, wherein the coating composition is applied to a fastener.

7. The coating of the claim 1, wherein the coating composition has a friction coefficient that is lower than about 0.2μ.
